(19) United States
(12) Patent Application Publication
(10) Pub. No.: US 2026/0057577 A1
(43) Pub. Date: Feb. 26, 2026

(54) ALIGNING TRACES TO GEOMETRIC SHAPES

(71) Applicant: Adobe Inc., San Jose, CA (US)

(72) Inventors: Gagan Singhal, Shakur Basti (IN); Shreya Anand, Roorkee (IN); Shikhar Tayal, ALIGARH (IN); Shefali Jain, Faridabad (IN); Nilesh Mishra, Kanpur (IN)

(21) Appl. No.: 18/810,818

(22) Filed: Aug. 21, 2024

(51) Int. Cl. G06T 11/20; G06T 3/40; G06T 7/13; G06V 10/74

(52) U.S. Cl. CPC G06T 11/203; G06T 3/40; G06T 7/13; G06V 10/761

(57) ABSTRACT

The present disclosure relates to systems, non-transitory computer-readable media, and methods for aligning curves to precise geometric shapes using a geometry matching algorithm. For example, the disclosed systems generate a set of discrete points along a curve depicted in a digital image by sampling the curve spanning between a first corner and a second corner depicted in the digital image. The disclosed systems determine an order for comparing the set of discrete points with a first geometry and a second geometry by comparing a centroid of the curve with a centroid of the first geometry and a centroid of the second geometry. The disclosed systems also determine, according to the order, a first similarity of the curve to the first geometry and a second similarity of the curve to the second geometry. The disclosed systems generate curve segments that align with one of the first geometry or the second geometry.

### BACKGROUND

In the realm of graphics design, creating designs that include geometric shapes is pivotal and foundational for generating many types of visual elements, ranging from simple to complex. From the intricate patterns of architecture to the sleek contours of modern logos, geometry influences shapes and designs across domains. Generating designs with precise geometric shapes, such as exact lines and arcs, is a complicated but important task. Over the years, systems have been developed to generate curves and trace outlines of objects. While existing systems provide some limited tools for tracing objects and generating curves, these systems exhibit a number of technical deficiencies, especially regarding accuracy and efficiency in generating or tracing curves for precise geometric shapes.

### SUMMARY

Embodiments of the present disclosure provide benefits and/or solve one or more of the foregoing or other problems in the art with systems, non-transitory computer-readable media, and methods for aligning curves to precise geometric shapes using a geometry matching algorithm. For example, the geometry matching process of the disclosed systems involves detecting corners in a digital image and using an advanced geometry matching algorithm to match precise geometries, such as arcs and lines, to curves spanning between corners in the digital image. In some embodiments, the geometry matching algorithm includes sampling a curve spanning between two corners to generate a set of discrete points for comparing with corresponding points of candidate geometries, such as a line and an arc. In some cases, the geometry matching algorithm also includes determining an order for comparing the curve with the candidate geometries and performing such comparisons to determine similarities between the curve and the candidate geometries. In one or more embodiments, the disclosed systems further utilize the geometry matching algorithm to generate curve segments (e.g., from input strokes or traces) aligning with a selected geometry according to a snapping threshold that dictates snapping the curve segments based on a degree of matching between the curve and the selected geometry. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a geometry matching system operates in accordance with one or more embodiments.

FIG. 2 illustrates an example overview of determining and tracing matching geometries for curves in a digital image in accordance with one or more embodiments.

FIG. 3 illustrates an example of detecting corners in a digital image in accordance with one or more embodiments.

FIG. 4 illustrates an example diagram of a geometry matching algorithm in accordance with one or more embodiments.

FIG. 5 illustrates an example curve for curve sampling in accordance with one or more embodiments.

FIG. 6 illustrates an example diagram of determining an order for similarity comparisons with candidate geometries in accordance with one or more embodiments.

FIG. 7 illustrates an example diagram of performing similarity comparisons in accordance with one or more embodiments.

FIG. 8 illustrates examples of generated curve segments based on different similarity thresholds in accordance with one or more embodiments.

FIG. 9 illustrates an example curve tracing interface in accordance with one or more embodiments

FIG. 10 illustrates an example schematic diagram for a geometry matching system in accordance with one or more embodiments.

FIG. 11 illustrates an example series of acts for determining and tracing matching geometries for curves of a digital image in accordance with one or more embodiments.

FIG. 12 illustrates a block diagram of an example computing device for implementing one or more embodiments of the present disclosure.

### DETAILED DESCRIPTION

This disclosure describes one or more embodiments of a geometry matching system that generates and aligns curves to precise geometric shapes using an advanced geometry matching algorithm. Geometric shapes are often foundational components of graphic designs, and aligning curves or traces to geometric shapes provides a powerful tool for accurate, efficient graphic design generation. As part of aligning curves to geometric shapes, the geometry matching system uses a geometry matching algorithm to sample a curve, order a similarity comparison of the curve in relation to candidate geometries (e.g., a line and an arc), perform the similarity comparisons in the order, and generate an output curve in the form of whichever candidate geometry is most similar according to the similarity comparisons. In some embodiments, the geometry matching system detects or determines corners depicted in a digital image and applies the geometry matching algorithm to a curve spanning between two detected corners. In certain cases, the geometry matching system performs downstream processes on a generated curve, such as vectorization or tracing of input strokes to align with a candidate geometry.

As just mentioned, in some embodiments, the geometry matching system detects corners depicted in a digital image. For example, the geometry matching system analyzes a graphical design or a digital image that depicts one or more objects to determine or detect corners. In some cases, the geometry matching system detects corners by resizing or rescaling an initial digital image (e.g., a raster image) and applying a corner detection algorithm that detects or determines corners where curves or edges of depicted objects intersect or end.

From the detected corners, in some embodiments, the geometry matching system performs a geometry matching process by applying a geometry matching algorithm. For example, the geometry matching system utilizes a geometry matching algorithm that includes various stages, processes, or subroutines. In some cases, the geometry matching algorithm involves: i) sampling a curve spanning between two detected corners, ii) determining an order for performing similarity comparisons of the curve, iii) performing the similarity comparisons to determine a geometry (e.g., a line or an arc) that matches, or is similar to, the curve (incorporating a similarity threshold), and iv) generating curve segments or strokes that align with or track the matching geometry.

As suggested above, many conventional systems exhibit a number of shortcomings or disadvantages, particularly in accurately tracing geometrical shapes in digital images. To elaborate, many existing systems rely on freehand tracing using digital pen tools, and while these systems might be able to trace a depicted object, the important geometrical information and orientation of underlying geometrical shapes is lost along the way. Indeed, most existing systems treat a depicted object as the source of truth or reference for tracing processes, aligning input strokes to the edges of the object. Depending on the imperfections present in the object, such existing systems are thus prone to imperfect tracing (by indiscriminately following the imperfections) stemming from gaps, holes, or deviations from precise geometric shapes found in the object. The inaccuracies of prior systems are more pronounced when applied to images with curves containing flaws in geometric shapes.

Due at least in part to their inaccuracies, many prior systems are also inefficient. For example, some existing systems consume excessive computer memory and storage by generating (e.g., through tracing) curves made up of an overabundance of edited curve segments. Indeed, due to the inaccuracies in their geometry tracing, certain prior systems require excessive numbers of device interactions to edit and refine traced curves for correcting errors to align with geometric shapes. Thus, prior systems waste computer storage with bloated tracing data and excessive interactions that define curves traced from images.

As suggested above, embodiments of the geometry matching system provide certain improvements or advantages over conventional systems. For example, embodiments of the geometry matching system improve accuracy in detecting and tracing geometric shapes from curves in digital images. Embodiments of the geometry matching system exhibit such accuracy improvements due to using a geometry matching algorithm (in combination with a corner detection algorithm) to determine and trace a geometry, such as a line or an arc, that matches a curve within a digital image. By using the geometry matching algorithm, the geometry matching system more accurately traces precise geometric shapes (and preserves geometric information and orientation) compared to prior non-geometry-based systems, especially for curves that are not exact matches but nevertheless satisfy a similarity threshold. The accuracy improvements of the geometry matching system are especially pronounced in images depicting flaws in otherwise precise geometrical shapes.

Due at least in part to improving accuracy over prior systems, embodiments of the geometry matching system also improve efficiency over prior systems. For instance, by using the geometry matching algorithm as the basis for tracing a digital image, the geometry matching system reduces the processing and storage requirements of tracing data compared to the overedited curves in prior systems. Indeed, the geometry matching system generates curves or strokes that precisely trace geometric shapes depicted (or within a threshold similarity of) a digital image, without requiring the additional editing or refining prevalent in prior systems. Thus, in some embodiments, the geometry matching system reduces the edit data and the number of device interactions for performing edits as compared to prior systems. Additionally, as opposed to prior systems that require many inputs to trace curves of an image, the geometry matching system provides a one-click tracing feature to detect and trace image curves with a single interaction.

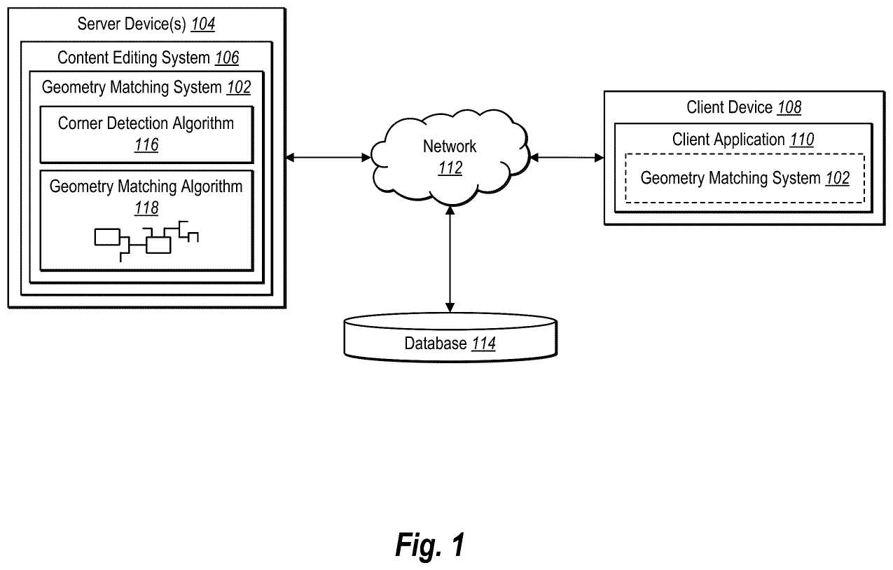

Additional detail regarding the geometry matching system will now be provided with reference to the figures. For example, FIG. 1 illustrates a schematic diagram of an example system environment for implementing a geometry matching system 102 in accordance with one or more embodiments. An overview of the geometry matching system 102 is described in relation to FIG. 1. Thereafter, a more detailed description of the components and processes of the geometry matching system 102 is provided in relation to the subsequent figures.

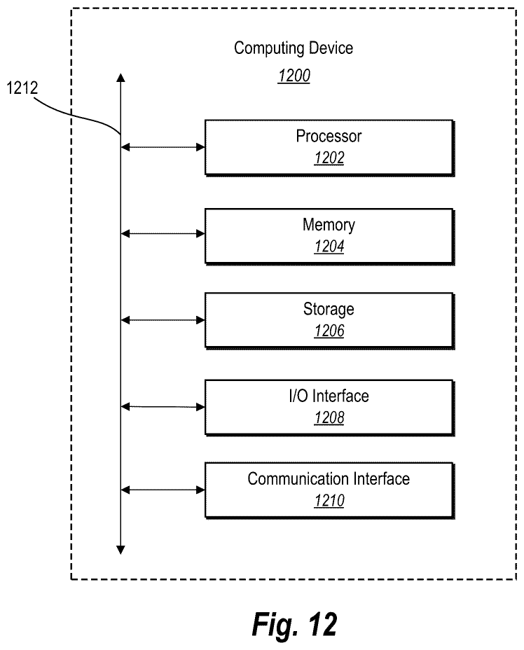

As shown, the environment includes server device(s) 104, a client device 108, a database 114, and a network 112. Each of the components of the environment communicate via the network 112, and the network 112 is any suitable network over which computing devices communicate. Example networks are discussed in more detail below in relation to FIG. 12.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 12. Although FIG. 1 illustrates a single instance of the client device 108, in some embodiments, the environment includes multiple different client devices, each associated with a different user. The client device 108 communicates with the server device(s) 104 and/or the content editing system 106 via network 112. For example, the client device 108 receives information from the server device(s) 104 and provides information to server device(s) 104 relating to raster images, vector images, curves, corners, and geometric shapes.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server device(s) 104. The client application 110 presents or displays information to a user, including a content editing interface for using tracing tools to detect, modify, and/or trace curves or edges of a digital image.

As also illustrated in FIG. 1, the environment includes the server device(s) 104. The server device(s) 104 generates, tracks, stores, processes, receives, and transmits electronic data, such as raster images, vector images, corners, curves, and/or vector data for tracing. For example, the server device(s) 104 receives data from the client device 108 in the form of a digital image and an indication to trace a curve depicted in the digital image. In response, the server device(s) 104 provides data to the client device 108 in the form of a vectorized image and/or detected edges, as described herein. For example, the server device(s) 104 communicate with the database 114 to access a pixel window algorithm 116 a trained neural network, such as the segmentation neural network 118.

In some embodiments, the server device(s) 104 communicates with the client device 108 to transmit and/or receive data via the network 112. In some embodiments, the server device(s) 104 comprises a distributed server where the server device(s) 104 includes a number of server devices distributed across the network 112 and located in different physical locations. The server device(s) 104 comprise a content server, an application server, a communication server, a web-hosting server, a multidimensional server, or a machine learning server.

As further shown in FIG. 1, the server device(s) 104 also includes the geometry matching system 102 as part of a content editing system 106. For example, in one or more implementations, the content editing system 106 stores, generates, modifies, edits, enhances, provides, distributes, and/or shares digital content, such as digital images. For example, the content editing system 106 provides digital content for editing or other forms of digital processing. In some implementations, the content editing system 106 provides digital content to particular digital profiles associated with client devices (e.g., the client device 108).

In one or more embodiments, the server device(s) 104 includes all, or a portion of, the geometry matching system 102. For example, the geometry matching system 102 operates on the server device(s) 104 to detect corners, determines similar geometries for curves, and/or convert raster images into vector images through curve tracing or fitting. In some embodiments, the client device 108 includes all or part of the geometry matching system 102. For example, the client device 108 generates, obtains (e.g., downloads), or uses one or more aspects of the geometry matching system 102, such as the corner detection algorithm 116 and/or the geometry matching algorithm 118. Indeed, in some implementations, as illustrated in FIG. 1, the geometry matching system 102 is located in whole or in part of the client device 108 (e.g., as part of the client application 110). For example, the geometry matching system 102 includes a web hosting application that allows the client device 108 to interact with the server device(s) 104. To illustrate, in one or more implementations, the client device 108 accesses a web page supported and/or hosted by the server device(s) 104.

In one or more embodiments, the client device 108 and the server device(s) 104 work together to train and/or implement models of the geometry matching system 102. For example, in some embodiments, the server device(s) 104 train one or more neural networks (e.g., neural networks used as part of the corner detection algorithm 116 to detect corners) and provide the one or more neural networks to the client device 108 for implementation. In some embodiments, the server device(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the geometry matching system 102 is implemented by (e.g., located entirely or in part on) the client device 108. As another example, the corner detection algorithm 116 and/or the geometry matching algorithm 118 are stored in the database 114. In addition, in one or more embodiments, the client device 108 communicates directly with the geometry matching system 102, bypassing the network 112.

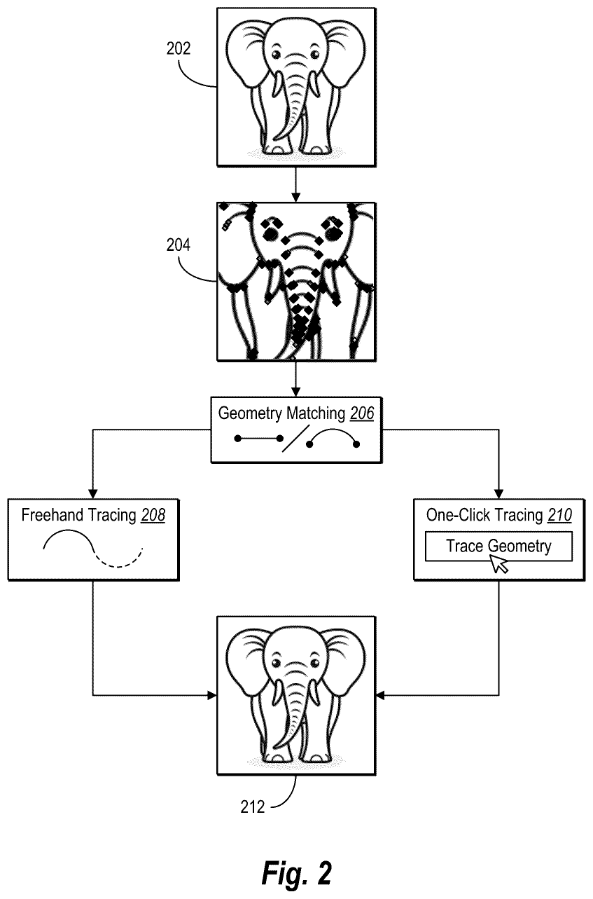

As mentioned, in one or more embodiments, the geometry matching system 102 traces geometric shapes from curves depicted in a digital image. In particular, the geometry matching system 102 utilizes a geometry matching algorithm to determine and trace geometries corresponding to curves in a digital image. FIG. 2 illustrates an example overview of in accordance with one or more embodiments. Additional detail regarding the various acts and processes introduced in relation to FIG. 2 is provided thereafter with reference to subsequent figures.

As illustrated in FIG. 2, the geometry matching system 102 identifies or receives a digital image 202. In particular, the geometry matching system 102 receives the digital image 202 as an upload or a selection from a client device. In some cases, the geometry matching system 102 receives the digital image 202 based on a selection from a digital image repository. In one or more embodiments, the digital image 202 is a raster image that depicts raster content (e.g., non-vectorized image content) arranged in a grid of individual pixels with pixel values. In some cases, a pixel value includes or refers to a numerical representation of a magnitude or intensity corresponding to an aspect of content depicted in a pixel, such as color or luminance. As shown, the digital image 202 is a line art drawing of an elephant.

As also illustrated in FIG. 2, the geometry matching system 102 detects or determines corners 204 within the digital image 202. Indeed, for embodiments where the digital image 202 is a raster image, the geometry matching system 102 utilizes a corner detection algorithm. To elaborate, the geometry matching system 102 rescales the digital image 202 into multiple rescaled versions, applies a corner detection algorithm that includes functions such as Harris corner detection or shi tomasi corner detection (along with other processes) to detect the corners 204 in the rescaled versions according to an adaptive corner detection threshold. For embodiments where the digital image 202 is a vector image, however, the geometry matching system 102 does not detect the corners 204 using a corner detection algorithm because the corners 204 are predefined-vector image data includes defined corner data among its vector paths and anchor points.

As further shown in FIG. 2, the geometry matching system 102 performs geometry matching 206. The geometry matching system 102 performs the geometry matching 206 by applying a geometry matching algorithm based on the corners 204. For example, the geometry matching system 102 determines curves depicted in the digital image 202, where each curve spans between two of the corners 204. For a given curve, the geometry matching system 102 generates a set of discrete points according to a curve sampling process that involves distance-based sampling at intervals along the curve.

In addition, the geometry matching 206 involves ordering similarity comparisons for each sampled curve. For instance, the geometry matching system 102 determines an order for comparing different geometries against the curve so that the similarity comparisons are performed in the determined order one after the other. In some cases, a geometry includes or refers to a geometrical shape such as a straight line, an arc (e.g., a section or segment of a circle), or some other shape. The geometry matching system 102 thus performs the similarity comparisons in the order by performing pairwise comparisons of points along the curve with corresponding points along the candidate geometry. In some embodiments, the geometry matching system 102 further applies similarity thresholds to determine which candidate geometry most resembles the curve.

As further illustrated in FIG. 2, in some embodiments, the geometry matching system 102 performs freehand tracing 208. In particular, the geometry matching system 102 receives tracing input or strokes from a client device, determines a curve of the digital image corresponding to the tracing input, and snaps or aligns the tracing input to the matching geometry for the curve. In some embodiments, the geometry matching system 102 uses one-click tracing 210 to generate or trace curves of a matching geometry in response to a single user interaction selecting a one-click tracing option. Either using freehand tracing 208 or one-click tracing 210, the geometry matching system 102 traces or generates curve segments or strokes (e.g., in vector format) along the determined geometry corresponding to the curve. The geometry matching system 102 thus generates the vector image 212 that depicts traced curve segments following precise geometric shapes.

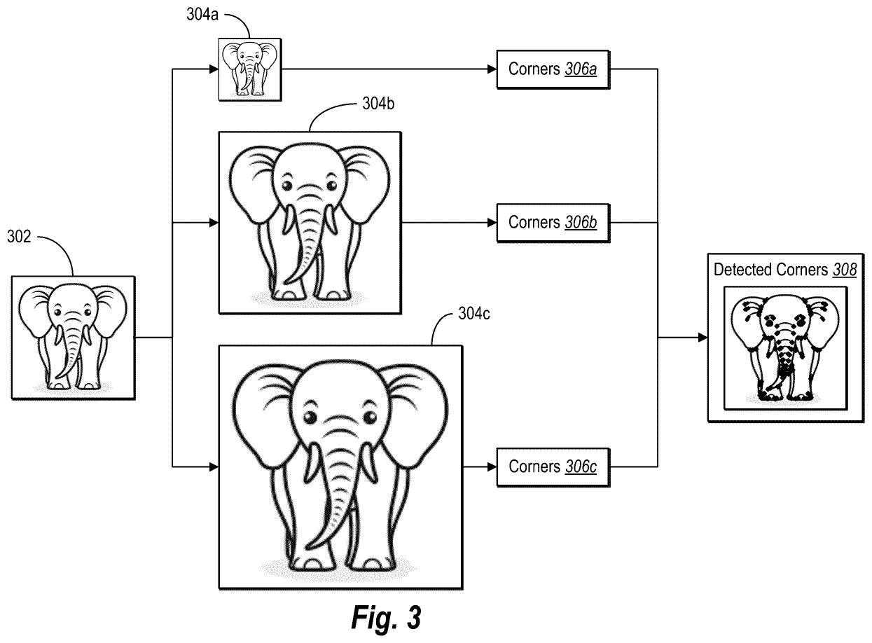

As noted, in certain described embodiments, the geometry matching system 102 detects corners in a digital image. In particular, the geometry matching system 102 utilizes a corner detection algorithm on a raster image or determines corner data from cubic Beziers of a vector image. FIG. 3 illustrates detecting corners in a digital image using a corner detection algorithm in accordance with one or more embodiments.

As illustrated in FIG. 3, the geometry matching system 102 determines or identifies a digital image 302. In addition, as part of a corner detection algorithm, the geometry matching system 102 performing a multi-level rescaling of the digital image 302 to generate multiple rescaled versions. For instance, the geometry matching system 102 generates a rescaled image 304a at ½ scale of the digital image 302, a rescaled image 304b at 1.5 times the digital image 302, and a rescaled image 304c at 2 times the digital image 302. In some cases, the geometry matching system 102 rescales the digital image 302 by performing Lanczos resampling for its effectiveness in preserving edge information during scaling. Using a multi-level rescaling improves the ability of the geometry matching system 102 to better visualize and process fine details and corners compared to prior systems, especially in images with lower resolutions and/or intricate details.

In addition, as part of the corner detection algorithm the geometry matching system 102 detects corners within the rescaled versions. For example, the geometry matching system 102 detects corners 306a from the rescaled image 340a by using a corner detection algorithm that identifies corners as points in a local neighborhood that show at least threshold changes in intensity in both orthogonal directions. Indeed, through the corner detection algorithm, the geometry matching system 102 determines image gradients using derivatives of Gaussian filters, determines structure tensors from the gradients, generates a matrix made up of structure tensors for each pixel in the image, and determines a corner response using the determinant and the trace of the matrix. The geometry matching system 102 uses the corner detection algorithm to detect corners in areas where one or more gradients or tensors in a corner matrix satisfy a particular gradient threshold. The geometry matching system 102 thus detects the corners 306a by applying a corner detection algorithm to the rescaled image 304. The geometry matching system 102 likewise detects the corners 306b from the rescaled image 304b and the corners 306c from the rescaled image 304c. In some embodiments, the geometry matching system 102 also detects corners from the digital image 302 in its initial scale as well.

As further illustrated in FIG. 3, the geometry matching system 102 generates or determines detected corners 308. To elaborate, as part of the corner detection algorithm, the geometry matching system 102 combines or merges the corners 306a, the corners 306b, and the corners 306c (and corners detected from the digital image 302 in its initial resolution) into the detected corners 308. As part of this process, the geometry matching system 102 scales the detected corners (in their respective rescaled images) back to the initial size of the digital image 302. The geometry matching system 102 further normalizes corners and applies an adaptive corner threshold. Particularly, the geometry matching system 102 adaptively determines a corner threshold based on a standard deviation of a corner response (as determined from a corner matrix) and a dynamic corner factor. The geometry matching system 102 derives the dynamic corner factor from edge density of the digital image 302, thus allowing the corner factor and the resultant corner threshold to vary based on image conditions. The geometry matching system 102 preserves and stores corners that satisfy (e.g., meet or exceed) the adaptive corner threshold as the detected corners 308, discarding or ignoring others.

In some embodiments, the geometry matching system 102 performs or applies a corner detection algorithm as represented by the following pseudo code:

Corner Detection Algorithm:

```
Data: Raster_Image
Result: Raster_Image with corners marked as circles
begin
Raster_Image_2x ← Resize the input Raster image to double size
Raster_Image_0.5x ← Resize the input Raster image to half size
Raster_Image_1.5x ← Resize the input Raster image to 1.5 size
corners ← corners data from corner Harris algorithm on Raster_Image
corners_2x ← corners data from corner Harris algorithm on Raster_Image_2x
corners_0.5x ← corners data from corner Harris algorithm on Raster_Image_2x
corners_1.5x ← corners data from corner Harris algorithm on Raster_Image_2x
corners ← Based on different corner data (corners, corners_2x, corners_0.5x, corners_1.5) on
multiple scales, determine the combined corner data and remove the duplicate corners
edgeData ← Get Edge Data of Raster Image;
Normalizing the corners output
mean, stddev ← scalars to get the mean and standard deviation;
edgeDensity ← CalculateEdgeDensity(RasterImage,EdgeData);
factor ← unitialised floating point value;
if edgeDensity < 0.05 then
  factor = 1.5;
else if edgeDensity > 0.2 then
  factor = 0.5;
else
  factor = 1.0;
threshold ← mean[0] + factor * stddev[0];
Draw circles around corners of the image
```

In these or other embodiments, the geometry matching system 102 determines an edge density of the digital image 302 to inform the dynamic corner factor and thus the adaptive corner threshold. For instance, the geometry matching system 102 determines the edge density according to an edge density algorithm represented by the following pseudo code:

Edge Density Algorithm:

```
Data: Raster_Image(cv::mat), Edge_Data(cv::Mat)
Result: Returns the density of edges in the image
begin
  edgePixels ← cv::countNonZero(Edge_Data)
  totalPixels ← Raster_Image.rows × Raster_Image.cols
  return edgePixels / totalPixels
end
```

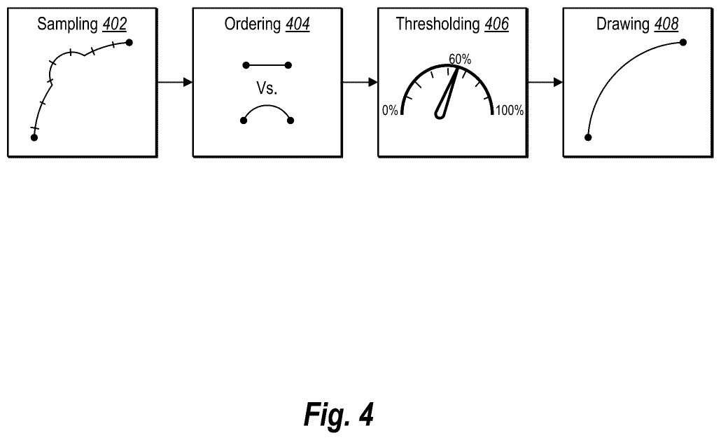

As indicated above, in certain embodiments, the geometry matching system 102 utilizes a geometry matching algorithm to generate or trace precise geometric shapes based on detected corners in a digital image. In particular, the geometry matching system 102 determines a curve spanning between two corners and further applies a geometry matching algorithm to determine and trace a geometric shape that corresponds to (e.g., matches or resembles) the curve. FIG. 4 illustrates an example diagram for a geometry matching algorithm in accordance with one or more embodiments.

As illustrated in FIG. 4, the geometry matching system 102 performs a sampling 402. To elaborate, the geometry matching system 102 samples a curve spanning between two corners depicted in a digital image. For example, the geometry matching system 102 samples the curve to generate a set of discrete points to approximate the continuous nature of the curve. In some embodiments, the geometry matching system 102 uses distance-based sampling to generate points in the set at evenly spaced intervals along the curve.

As further illustrated in FIG. 4, the geometry matching system 102 performs an ordering 404. In particular, the geometry matching system 102 determines an order for performing similarity comparisons of a curve. Indeed, the geometry matching system 102 determines a set of candidate geometries for comparing against a curve, where one of the candidate geometries will ultimately be traced. For example, the geometry matching system 102 determines candidate geometries such as a straight line and an arc. In addition, the geometry matching system 102 determines an order or a sequence for comparing the candidate geometries with a curve (e.g., by determining which to compare first, second, and so on). As described in further detail below, the geometry matching system 102 determines the order by generating and comparing centroids of candidate geometries with a centroid of a curve.

Additionally, as shown in FIG. 4, the geometry matching system 102 performs a thresholding 406. The geometry matching system 102 performs the thresholding 406 as part of similarity comparisons against candidate geometries. For example, the geometry matching system 102 performs a first similarity comparison to determine a similarity of a curve in relation to a first candidate geometry (e.g., first in the order determined via the ordering 404). In some cases, the geometry matching system 102 determines a similarity by performing pairwise comparisons of points among the set of discrete points sampled along a curve to corresponding points along a candidate geometry. As part of a similarity comparison, the geometry matching system 102 also applies a similarity threshold such that a curve satisfying a similarity threshold in relation to a candidate geometry is designated or defined as matching or corresponding to the candidate geometry. The geometry matching system 102 likewise applies thresholds to similarity comparisons with one or more subsequent candidate geometries as well.

As further illustrated in FIG. 4, the geometry matching system 102 performs a drawing 408. In particular, the geometry matching system 102 performs the drawing 408 to generate curve segments or strokes that align with a geometry that matches or corresponds to a curve. For example, if the geometry matching system 102 determines that a curve between two corners matches an arc (via the sampling 402, ordering 404, and thresholding 406), then the geometry matching system 102 generates curve segments for tracing or aligning with the arc. Indeed, the geometry matching system 102 generates curve segments to align or snap input strokes with the arc as part of a tracing process as the input strokes are received from a client device.

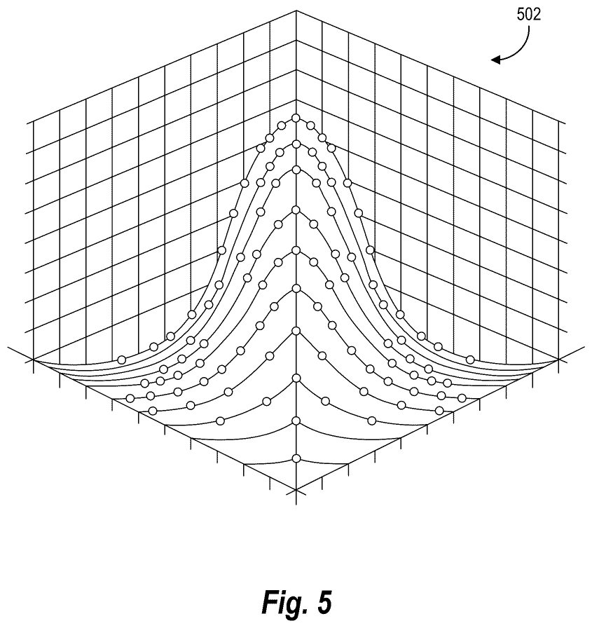

As noted, in one or more embodiments, the geometry matching system 102 performs a curve sampling as part of a geometry matching algorithm. In particular, the geometry matching system 102 samples along a curve spanning between two corners of a digital image to generate a set of discrete points along the curve. FIG. 5 illustrates an example curve sampling in accordance with one or more embodiments.

As illustrated in FIG. 5, the geometry matching system 102 samples a curve 502 to generate a set of discrete points (indicated by the open circles or dots) that resemble or reflect the shape of the curve 502. In one or more embodiments, the geometry matching system 102 samples the curve 502 by using a uniform sampling approach for intervals between sampled points. For instance, the geometry matching system 102 performs uniform curve sampling according to the following function:

$${Point}_{i} = Start Point + i \times Δ x$$

where Δx represents the distance of the interval between sample points. In some cases, the geometry matching system 102 samples consecutive points along the domain of the curve function using an interval that depends on the curve itself. For example, the geometry matching system 102 uses a smaller interval for more intricate curves (e.g., with more direction changes and detail) and a larger interval for less intricate curves.

In some embodiments, the geometry matching system 102 represents or defines a curve between two corners as a set of vector paths in the form of cubic Beziers. For samples, the geometry matching system 102 uses the sampling interval in conjunction with the Bezier representation of the curve to determine points selected at regular intervals along the domain. The geometry matching system 102 determines point positions starting at a specific point and adding the sampling interval repeatedly, taking into account the next Bezier path at each step.

In one or more embodiments, the geometry matching system 102 adjusts the sampling parameters. More particularly, the geometry matching system 102 adjusts the interval for different curves of the same image based on characteristics (e.g., direction changes or other details) of the curve. In some cases, the geometry matching system 102 stores or saves the set of discrete points along the curve. For example, the geometry matching system 102 stores the set of discrete points in an array, a list, or some other data structure. In one or more embodiments, the geometry matching system 102 samples a curve to generate a set of discrete points according to the following sampling algorithm:

Sampling Algorithm:

```
Data: CurveData , maxSamplingDistance
Result: samplePoints
begin
  samplePoints ← vector to store sample points
  totalSegments ← size of CurveData
  startIndex ← 0
  endIndex ← totalSegments − 1
  for currentIndex ← startIndex to endIndex − 1 do
    samplePoints ← Add samples from Bezier at index currentIndex using
    maxSampling distance.
  end
  if isClosed then
    samplePoints ← Add samples from Bezier at index currentIndex using
    maxSampling distance and determine whether to close or not based on end of
    Bezier.
  else
    lastPoint ← curveData[endIndex].p
    samplePoints.emplace_back(lastPoint)
  end
  return samplePoints
end
```

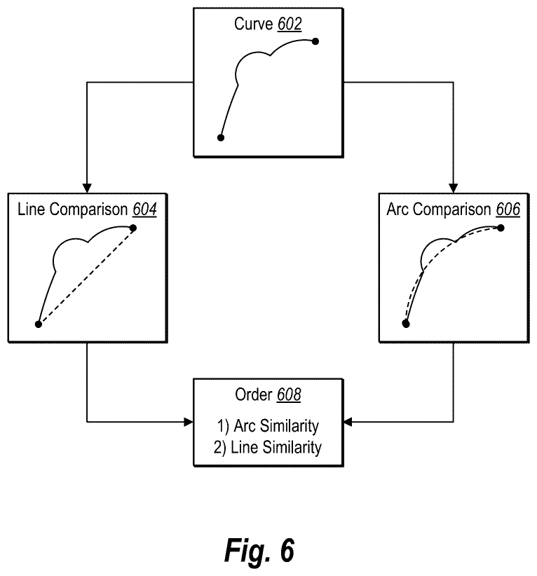

As mentioned above, in certain described embodiments, the geometry matching system 102 determines an order for performing similarity comparisons as part of a geometry matching algorithm. In particular, the geometry matching system 102 determines an order for comparing candidate geometries against a curve. FIG. 6 illustrates an example diagram for determining an order of similarity comparisons in accordance with one or more embodiments.

As illustrated in FIG. 6, the geometry matching system 102 determines a curve 602. As described, the geometry matching system 102 determines the curve 602 as an edge or a cubic Bezier spanning between two corners in a digital image. In addition, the geometry matching system 102 determines an order 608 by which to compare the curve 602 with candidate geometries. To determine the order 608, the geometry matching system 102 performs a preliminary line comparison 604 and a preliminary arc comparison 606.

To perform the preliminary line comparison 604, the geometry matching system 102 determines a centroid of the curve and a centroid of a straight line spanning between the same two corners as the curve. In some embodiments, a centroid is a geometric center or average position of a curve or of a set of discrete points sampled along the curve. For the curve 602 defined as a set of discrete points in two-dimensional space (x, y), the geometry matching system 102 determines a centroid according to the following functions:

$${C}_{x} = \frac{1}{N} {\sum }_{i = 1}^{N} {x}_{i}$$

$$and$$

$${C}_{y} = \frac{1}{N} {\sum }_{i = 1}^{N} {y}_{i}$$

where (Cₓ, C_{y}) represents the centroid of the curve 602. Indeed, the geometry matching system 102 determines the centroid as the average of x-coordinates and y-coordinates of the points in the set of discrete points. Assuming each point has equal mass, the centroid thus represents the center of mass.

As part of the line comparison 604, the geometry matching system 102 further generates a line spanning between the same two corners as the curve 602 and generates a set of discrete points along the line. More specifically, the geometry matching system 102 generates the discrete points starting from one corner and extending in a straight line to the other corner using a unique line point algorithm. For instance, the geometry matching system 102 uses a line point algorithm to sample the line at uniform intervals from the start corner to the end corner according to a number of divisions. In some embodiments, the geometry matching system 102 implements a line point algorithm represented by the following pseudo code:

Line Point Algorithm:

```
Data: start_point, end_point, numberOfDivisions
Result: Returns vector of point containing points on the line
begin
  lengthOfLine ← Compute cartesian distance between start_point and end_point
  distanceOnLine ← lengthOfLine / numberOfDivisions
  pointsOnLine ← new vector of points
  for i ← 1 to numberOfDivisions do
    distance ← distanceOnLine × i
    point ← find point on a line at a distance of distance / lengthOfLine with start and
    end point as start_point, end_point
    pointsOnLine.push_back(point)
  end
  return pointsOnLine
end
```

Additionally, as part of the line comparison 604, the geometry matching system 102 determines a centroid of the line according to the centroid functions above. The geometry matching system 102 further compares the centroid of the line with the centroid of the curve 602. For instance, the geometry matching system 102 compares the positions of the two centroids. For example, the geometry matching system 102 determines a Euclidean distance between the centroids according to the following formula:

$$Distance = \sqrt{{( {C}_{x 1} - {C}_{x 2} )}^{2} + {( {C}_{y 1} - {C}_{y 2} )}^{2}}$$

where (Cₓ₁, C_{y1}) represents the centroid of the curve and (Cₓ₂, C_{y2}) represents the centroid of the line (or vice-versa).

Similarly, to perform the preliminary arc comparison 606, the geometry matching system 102 generates an arc spanning between the same two corners as the curve 602 and generates a set of discrete points along the arc. More specifically, the geometry matching system 102 generates the discrete points starting from one corner and extending in a perfect arc to the other corner using a unique arc point algorithm. For instance, the geometry matching system 102 uses an arc point algorithm to sample the arc at uniform intervals from the start corner to the end corner according to a number of divisions. In some embodiments, the geometry matching system 102 implements an arc point algorithm represented by the following pseudo code:

Arc Point Algorithm:

```
Data: start_point, end_point, pointOnArc, numberOfDivisions
Result: Returns vector of AIRealPoint containing points on the arc
begin
  pointsOnArc ← new vector of points
  center ← Determine center between start_point, end_point and pointOnArc
  radius ← Compute cartesian distance between start_point and center
  angleOfArc ← Compute the angle between start_point, end_point and center and then
  normalize the angle.
  isClockwise ← Check if curve is clockwise based on start_point, pointOnArc, end_point
  if isClockwise then
    angleOfArc ← (2 × π) − angleOfArc
  arcLength ← angleOfArc × radius
  distanceOnArc ← arcLength / numberOfDivisions
  for i ← 0 to numberOfDivisions−1 do
    angleToRotate ← (i × distanceOnArc) / radius
    if isClockwise then
      angleToRotate ← (2 × π) − angleToRotate
    point←find rotated point of startpoint,
    rotatedatvalueofangleToRotatewiththereferenceascenterpoints
    pointsOnArc.push_back(point)
return pointsOnArc
```

Similar to the description of the line comparison 604, the geometry matching system 102 further determines and compares a centroid of the arc with the centroid of the curve 602. For example, the geometry matching system 102 determines a Euclidean distance from the curve centroid to the arc centroid according to the formula above, but with (Cₓ₂, C_{y2}) representing the centroid of the arc rather than the line.

In one or more embodiments, the geometry matching system 102 further compares the distances of the centroids. Indeed, the geometry matching system 102 compares a distance from the centroid of the curve 602 to the centroid of the line with a distance from the centroid of the curve 602 to the centroid of the arc. In addition, the geometry matching system 102 determines the order 608 according to a comparison of the distances, with the candidate geometry (e.g., the arc) having the shortest distance ordered first and the candidate geometry (e.g., the line) having the longest distance ordered last. By ordering according to preliminary comparisons in this way, the geometry matching system 102 improves efficiency over systems that might otherwise be more computationally expensive in determining curve similarities with candidate geometries.

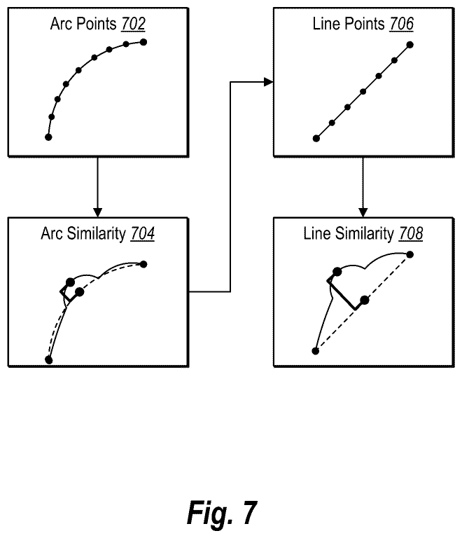

As mentioned above, in certain described embodiments, the geometry matching system 102 determines similarities of a curve in relation to candidate geometries. In particular, the geometry matching system 102 compares a curve with a first candidate geometry and with a second candidate geometry according to the order determined as described. FIG. 7 illustrates an example diagram for determining similarities of a curve in relation to candidate geometries in accordance with one or more embodiments.

As illustrated in FIG. 7, the geometry matching system 102 accesses or identifies arc points 702. Indeed, as described, the geometry matching system 102 generates arc points 702 between the same two corners where the curve spans. Using the arc points 702, the geometry matching system 102 determines or generates an arc similarity 704. More particularly, the geometry matching system 102 determines the arc similarity 704 as a similarity score based on pairwise distances between points of the curve and points of the arc. In some embodiments, the geometry matching system 102 determines pairwise point distances by determining distances between like points along the curve and the arc (e.g., where the points are sampled at the same interval along each path and there are the same number of points between the corners).

In one or more embodiments, the geometry matching system 102 determines the arc similarity 704 using an L2 norm distance (or root mean square distance) for pairwise distances. For example, the geometry matching system 102 determines the pairwise distances (as Euclidean distances given by the formula above to indicate horizontal and vertical differences) between corresponding points and generates an average distance from the pairwise distances. In some embodiments, the geometry matching system 102 determines smaller distances to indicate greater similarity between the curve and a candidate geometry.

Additionally, in some embodiments, the geometry matching system 102 determines or generates a success ratio and an outlier ratio for two paths being compared (e.g., the curve and the arc). For example, the geometry matching system 102 samples the curve and the arc at n points and determines a number of the n points with pairwise distances less than a limiting value and determines a number of the n points with pairwise distances greater than an outlier value. In some cases, the geometry matching system 102 determines a success ratio and an outlier ratio according to the following formulas:

$$SuccessRatio = \frac{SuccessCount}{n}$$

$$and$$

$$OutlierRatio = \frac{OutlierCount}{n}$$

where SuccessCount represents the number of the n points with distances less than the limiting value (which is adjustable or adaptive) and OutlierCount represents the number of the n points with distances above an outlier value (which is adjustable or adaptive). In some embodiments, the geometry matching system 102 determines a similarity score in the form of the success ratio or a combination of the success ratio and the outlier ratio.

In one or more embodiments, the geometry matching system 102 determines a success ratio and/or an outlier ratio utilizing a matching ratio algorithm. For instance, the geometry matching system 102 uses a matching ratio algorithm represented by the following pseudo code:

Matching Ratio Algorithm:

```
Data: pointsOnCurve1, pointsOnCurve2, successRatio, outlierRatio
Result: SucessRatio and OutlierRatio
begin
  thresholdDistance ← 4.0
  upperLimitDistance ← 8.0
  numberOfDivisions ← pointsOnCurve1.size( )
  for i ← 0 to numberOfDivisions do
    distanceBetweenPoints ← Compute cartesian distance between
    pointsOnCurve1[i] and pointsOnCurve2[i];
    if distanceBetweenPoints <= thresholdDistance then
      output++
    else if distanceBetweenPoints >= upperLimitDistance then
      outliers++
successRatio = output/numberOfDivisions
outlierRatio = outliers/numberOfDivisions
```

As further illustrated in FIG. 7, the geometry matching system 102 accesses or determines line points 706. For instance, the geometry matching system 102 determines the line points 706 by sampling a line spanning between the same two corners as the target curve for comparison. Indeed, the geometry matching system 102 uses the line point algorithm above to generate line points for comparing with the set of discrete points along the curve.

In addition, the geometry matching system 102 determines or generates a line similarity 708. Similar to the discussion above regarding the arc similarity 704, the geometry matching system 102 performs pairwise distance comparisons of the line points 706 with corresponding points of the target curve (e.g., the curve with the hump in it as shown in the figure). The geometry matching system 102 determines the line similarity 708 as a similarity score based on pairwise distances between points of the curve and points of the arc. In some embodiments, the geometry matching system 102 determines pairwise point distances by determining distances between like points along the curve and the line (e.g., where the points are sampled at the same interval along each path and there are the same number of points between the corners).

In one or more embodiments, the geometry matching system 102 determines the line similarity 708 using an L2 norm distance (or root mean square distance) for pairwise distances. For example, the geometry matching system 102 determines the pairwise distances (as Euclidean distances given by the formula above to indicate horizontal and vertical differences) between corresponding points and generates an average distance from the pairwise distances. In some embodiments, the geometry matching system 102 determines smaller distances to indicate greater similarity between the curve and a candidate geometry.

Additionally, in some embodiments, the geometry matching system 102 determines or generates a success ratio and an outlier ratio for two paths being compared (e.g., the curve and the line). Indeed, the geometry matching system 102 uses the success ratio and outlier ratio formulas above. In some embodiments, the geometry matching system 102 determines a similarity score in the form of the success ratio or a combination of the success ratio and the outlier ratio.

While FIG. 7 illustrates one possible order for determining similarities (arc first then line), in some embodiments the geometry matching system 102 determines similarities in a different order. For instance, the geometry matching system 102 determines a different order which dictates determining the line similarity 708 before the arc similarity 704.

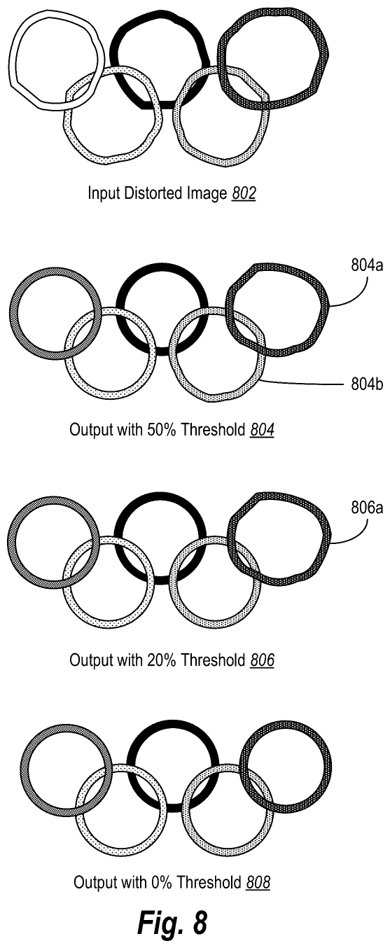

As noted, in certain embodiments, the geometry matching system 102 uses thresholding as part of the similarity determination between a curve and a candidate geometry. In particular, the geometry matching system 102 designates a curve as matching (or corresponding to) a candidate geometry based on determining that a similarity of the curve in relation to the candidate geometry satisfies a similarity threshold. FIG. 8 illustrates an example set of images comparing results of different similarity thresholds in accordance with one or more embodiments.

As illustrated in FIG. 8, the geometry matching system 102 identifies or receives a distorted input image 802. As shown, the distorted input image depicts five overlapping rings, all of which resemble circular shapes but none of which are perfectly circular. Each of the rings has bumps, distortions, and imperfections.

As further illustrated in FIG. 8, the geometry matching system 102 generates a modified image 804 from the distorted input image 802. In particular, the geometry matching system 102 generates the modified image 804 by detecting corners and using a geometry matching algorithm as described herein. As part of the geometry matching algorithm, the geometry matching system 102 designates curves in the distorted input image 802 as matching candidate geometries using a 50% threshold. To elaborate, the geometry matching system 102 sets a similarity threshold as a degree to which a curve matches or aligns with a candidate geometry (e.g., a line or an arc). In some cases, a similarity threshold indicates or represents a threshold percentage value for the success ratio of a curve, while in other cases the similarity threshold indicates a threshold percentage value for a combination of the success ratio and the outlier ratio. Either way, the geometry matching system 102 designates a curve as matching a candidate geometry upon determining that the curve satisfies the similarity threshold in relation to the candidate geometry.

In addition, the geometry matching system 102 snaps curves to their matching geometries. For example, the geometry matching system 102 generates replacement curve segments or strokes to align with or snap to corresponding geometries, such as lines or arcs. The geometry matching system 102 thus generates the modified image 804, the modified image 806, and the modified image 808 using different similarity thresholds. In some cases, the geometry matching system 102 uses a curve snapping algorithm represented by the following pseudo code:

Curve Snapping Algorithm:

```
Data: CurveData, Threshold
Result: Returns the snapped curve if applicable
begin
  numberOfSegments ← size of CurveData in terms of path segments
  start ← first point of CurveData
  end ← last point of CurveData
  if start == end then
    return CurveData
  if numberOfSegments == 2 then
    return CurveData
  pointsOnCurve ← Call SampleCurveData(CurveData, samplingDistance)
  numberOfDivisions ← size of pointsOnCurve
  pointsOnLine ← GetPointsOnLine(start, end, numberOfDivisions)
  pointOnArc ← pointsOnCurve at median point index which is numberOfDivisions / 2
  if start point, point on arc and end point is collinear then
    return GetSegmentsForLine(CurveData[0], CurveData[size−1]);
  pointsOnArc ← GetPointsOnArc(start, end, pointOnArc, numberOfDivisions)
  outputForLine, outliersForLine, outputForArc, outliersForArc ← 0
  successRatioForLine, outlierRatioForLine, successRatioForArc, outlierRatioForArc ← 0
  if threshold equals 0 then
  GetCurveMatchingRatios(pointsOnCurve, pointsOnLine, sucessRatioForLine,
  outlierRatio-ForLine)
  GetCurveMatchingRatios(pointsOnCurve, pointsOnArc, sucessRatioForArc, outlierRatio-
  ForArc)
    return SnapToGeometryWithZeroThreshold(successRatioForLine,
    successRatioForArc, CurveData, pointOnArc)
  centroidOfCurve, centroidOfArc, centroidOfLine ← Determine centroid Of a Curve based
  on pointsOnCurve, pointsOnArc and pointsOnLine, respectively;
  distanceFromLine, distanceFromArc ← Compute the cartesian distance between centroid-
  OfCurve and centroidOfLine, centroidOfArc respectively;
  if distanceFromLine < distanceFromArc then
    GetCurveMatchingRatios(pointsOnCurve, pointsOnLine, sucessRatioForLine,
    outlierRatioForLine)
    if successRatioForLine > threshold AND outlierRatioForLine < 0.1 then
      return GetSegmentsForLine(CurveData[0], CurveData[size−1]);
    GetCurveMatchingRatios(pointsOnCurve, pointsOnArc, sucessRatioForArc,
    outlierRatioForArc)
    if successRatioForArc > threshold AND outlierRatioForArc < 0.1 then
      return GetSegmentsForArc(CurveData[0], pointOnArc, CurveData[size−1]);
  else
    GetCurveMatchingRatios(pointsOnCurve, pointsOnArc, sucessRatioForArc,
    outlierRatioForArc)
    if successRatioForArc > threshold AND outlierRatioForArc < 0.1 then
      return GetSegmentsForArc(CurveData[0], CurveData[size−1]);
  GetCurveMatchingRatios(pointsOnCurve, pointsOnLine, sucessRatioForLine,
  outlierRatioForLine)
    if successRatioForLine > threshold AND outlierRatioForLine < 0.1 then
      return GetSegmentsForLine(CurveData[0], pointOnArc, CurveData[size−1]);
  return CurveData
```

As further illustrated in FIG. 8, the geometry matching system 102 adjusts or modifies a similarity threshold (e.g., based on interaction with a client device to set the threshold) which results in different outputs from the same input. Indeed, the geometry matching system 102 generates the modified image 804 using a 50% threshold, resulting in the curves of first three rings from left to right matching arcs. As shown, the modified image 804 shows perfect circles (or multiple conjoined arcs) for the first three rings as they satisfy the similarity threshold and the geometry matching system 102 generates curve segments or strokes to align with or trace the arc in their place.

However, the geometry matching system 102 determines, through the geometry matching algorithm, that the last two rings do not satisfy the 50% similarity threshold (meaning that at least 50% of the pairwise distance comparisons of points meet the limiting value) in relation to an arc, and they therefore remain distorted. Indeed, the geometry matching system 102 maintains the ring 804a and the ring 804b as distorted for not satisfying the similarity threshold to trace an arc. In some cases, the geometry matching system 102 replaces some curves of ring 804a and the ring 804b between various corners if they satisfy the 50% threshold, while keeping other curves untouched and distorted.

In addition, the geometry matching system 102 generates a modified image 806 from the distorted input image 802 using a similarity threshold of 20%. In other words, the geometry matching system 102 performs the geometry matching algorithm and generates strokes to trace geometries that match the curves of the rings in the distorted input image 802, this time with a 20% similarity threshold. Accordingly, the geometry matching system 102 generates strokes to replace original curves with points that satisfy at least a 20% success ratio (or a combination of the success ratio and the outlier ratio). As shown, the modified image 806 includes four rings that have been corrected and replaced with circles, while the ring 806a remains distorted as it fails the 20% similarity threshold.

As further illustrated in FIG. 8, the geometry matching system 102 generates a modified image 808 from the distorted input image 802 using a 0% similarity threshold. In particular, the geometry matching system 102 utilizes a zero-percent threshold to essentially force a binary decision between matching one geometry (e.g., an arc) or another geometry (e.g., a line). Thus, for each curve, the geometry matching system 102 determines if the curve is more similar to a line or an arc and designates to most similar geometry as matching. The geometry matching system 102 thus generates curve segments to replace the curve by tracing the line or the arc (whichever is most similar). As shown, the modified image 808 depicts all five rings with corrected curves following perfect arcs or circles. Indeed, the geometry matching system 102 uses a zero-percent similarity threshold to snap a curve to a candidate geometry.

In some embodiments, the geometry matching system 102 uses a zero-percent similarity threshold to snap a curve to a candidate geometry according to the following pseudo code:

Curve Snapping Algorithm:

```
Data: lineSuccess, arcSuccess, curveData, pointOnArc
Result: Returns vector of curveData snapped to either a line or an arc
begin
  numberOfCurveDataSegments ← size of curveData
  modifiedData ← new vector of curveData
  if lineSuccess > arcSuccess then
    modifiedData ← Call GetSegmentsForLine(CurveData[0], CurveData[size−1]);
    return modifiedData
  else
    modifiedData ← Call GetSegmentsForArc(CurveData[0], pointOnArc,
    CurveData[size−1]);
    return modifiedData
```

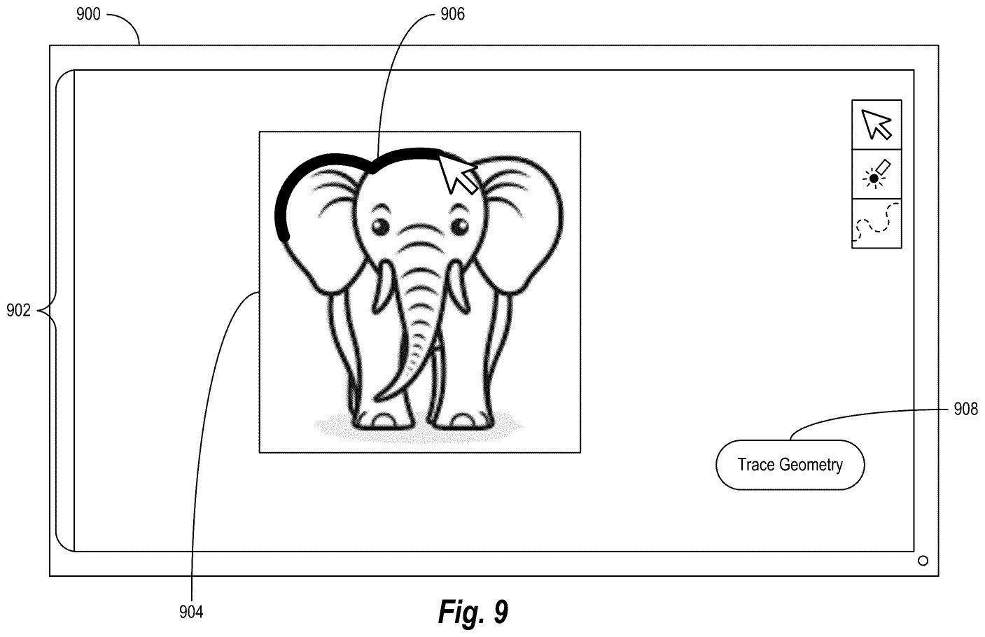

As mentioned above, in certain described embodiments, the geometry matching system 102 provides a curve tracing interface for tracing geometries corresponding to curves in digital images. In particular, the geometry matching system 102 provides interface tools for executing freehand tracing and/or one-click tracing. FIG. 9 illustrates an example computing device displaying a curve tracing interface in accordance with one or more embodiments.

As illustrated in FIG. 9, the geometry matching system 102 generates and provides a curve tracing interface 902 for display on a client device 900. Within the curve tracing interface 902, the geometry matching system 102 provides a digital image 904 for display. In some cases, the digital image 904 is a raster image while in other cases the digital image 904 is a vector image. In addition, the geometry matching system 102 analyzes or processes the digital image 904 to detect or otherwise identify corners using a corner detection algorithm and to determine matching geometries to curves spanning between the corners using a geometry matching algorithm.

As shown, the geometry matching system 102 further generates a tracing stroke 906 from tracing input received from the client device 900 (e.g., via dragging a cursor or finger). Indeed, the geometry matching system 102 determines, through the algorithms described, a matching geometry (e.g., a line or an arc) for each traced segment and aligns the input strokes with its matching geometry. In some cases, the geometry matching system 102 determines that input strokes are within a threshold distance of a curve and thus snaps the input traces to the matching geometry even if the strokes to not trace or follow the geometry precisely. As shown, the geometry matching system 102 aligns the tracing stroke 906 with two different arcs (one for each of two traced curves), one along the ear and another along the head of the elephant.

As further shown in FIG. 9, the geometry matching system 102 provides a single-click option 908. Indeed, in response to receiving a user interaction selecting the single-click option 908, the geometry matching system 102 traces all curves in the digital image 904, snapping tracing strokes to matching geometries of each curve. In some cases, the geometry matching system 102 generates the tracing strokes in vector format, effectively converting a raster image into a vector image in cases where the digital image 904 is in raster form. For instance, the geometry matching system 102 uses a tracing or curve fitting algorithm such as Vectormitate as described by G. Singhal et al. in U.S. patent application Ser. No. 18/483,919, titled VECTOR PATH TRAJECTORY IMITATION, filed Oct. 10, 2023, which is hereby incorporated by reference in its entirety.

In one or more embodiments, the geometry matching system 102 snaps tracing input strokes (or existing curves of the digital image 904) via the client device 900 to a matching geometry of a curve according to one or more geometry-specific tracing algorithms. For instance, the geometry matching system 102 uses an arc tracing algorithm represented by the following pseudo code:

Arc Tracing Algorithm:

```
Data: start_point, pointOnCurve, end_point
begin
  center, clockness, quarter ← Determine center, clockness and number of quarters of arc
  directionMult ← if clockwise is true then return 1 else −1
  while true do
    segment1, segment2 ← Initialize start and end point of curve
    segment1.out ← start.p +
    (perpendicularVec*kAIRealAvogadrosOther*directionMult);
    midPointOnArc1 ← start.p + r + (perpendicularVec*directionMult);
    segment2.p (point) ← midPOnArc1;
    segment2.in (inTangent) ← midPOnArc1 − (r*kAIRealAvogadrosOther);
    segment2.out (outTangent) ← midPOnArc1 + (r*kAIRealAvogadrosOther);
    if quarters == 0 then
      fragmentedSegments ← split Bezier based on segment1, segment2 and end
      point
      segments ← copy fragmentedSegments in segments at back, break
    end
    segments.push_back(segment1), Decrement quarters by 1
    diameterEnd ← start point + (r*2)
    segment3.p ← diameterEnd
    segment3.in(segment inTangent) ← diameterEnd + (perpendicularVec*
    kAIRealAvogadrosOther*directionMult)
    segment3.out(segment outTangent) ← diameterEnd − (perpendicularVec*
    kAIRealAvogadrosOther*directionMult);
    if quarters ≠ 0 then
      fragmentedSegments ← split Bezier based on segment2, segment3 and end
      point
      segments ← copy fragmentedSegments in segments at back, break;
    end
    segments.push_back(segment2), Decrement quarters by 1;
    midPOnArc2 ← start.p + r − (perpendicularVec*directionMult)
    segment4.p← midPOnArc2
    segment4.in← midPOnArc2 + (r*kAIRealAvogadrosOther)
    segment4.out← midPOnArc2 − (r*kAIRealAvogadrosOther)
    if quarters == 0 then
      fragmentedSegments ← split Bezier based on segment3, segment4 and end
      point
      segments ← copy fragmentedSegments in segments at back, break;
    end
    segments.push_back(segment3), Decrement quarters by 1;
    segment5.p← start.p (start point)
    segment5.in← start.p −
    (perpendicularVec*kAIRealAvogadrosOther*directionMult)
    segment5.out← m start.p +
    (perpendicularVec*kAIRealAvogadrosOther*directionMult)
    if quarters == 0 then
      fragmentedSegments ← split Bezier based on segment4, segment5 and end
      point
      segments ← copy fragmentedSegments in segments at back, break;
    end
    segments.push_back(segment4), Decrement quarters by 1;
    segments.front( ).in = segment5.in, fixEnd = false;
    break;
  end
  if fixEnd then
    segments.back( ).p = p2; segments.back( ).out = end.out;
  end
end
```

In certain embodiments, the geometry matching system 102 uses a line tracing algorithm represented by the following pseudo code:

Line Tracing Algorithm:

```
Data: start_point, end_point
Result: segments <vector of curve data>
begin
  segments ← vector of curve data paths of size 2
  segments[0] ← start_point
  segments[0].out ← segments[0].point
  segments[1] ← end_point
  segments[1].in ← segments[1].point
end
```

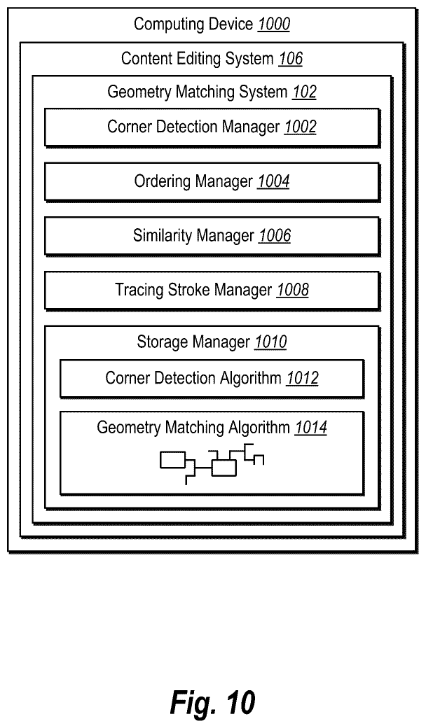

Looking now to FIG. 10, additional detail will be provided regarding components and capabilities of the geometry matching system 102. Specifically, FIG. 10 illustrates an example schematic diagram of the geometry matching system 102 on an example computing device 1000 (e.g., one or more of the client device 108 and/or the server device(s) 104). In some embodiments, the computing device 1000 refers to a distributed computing system where different managers are located on different devices, as described above. As shown in FIG. 10, the geometry matching system 102 includes a corner detection manager 1002, an ordering manager 1004, a similarity manager 1006, a tracing stroke manager 1008, and a storage manager 1010.

As just mentioned, the geometry matching system 102 includes a corner detection manager 1002. In particular, the corner detection manager 1002 manages, maintains, detects, determines, generates, or identifies corners depicted in a digital image. In some embodiments, for raster images, the corner detection manager 1002 utilizes a corner detection algorithm to detect corners. In other embodiments, for vector images, the corner detection manager 1002 looks up or identifies corner data defining corners from cubic Beziers defining the vectors with paths and anchor points.

As shown, the geometry matching system 102 also includes an ordering manager 1004. In particular, the ordering manager 1004 manage, maintains, determines, generates, sorts, orders, or identifies an order for performing similarity comparisons of curves to candidate geometries. For example, the ordering manager 1004 compares a curve spanning between two corners with candidate geometries (e.g., a line and an arc or some other geometric shape or path) spanning between the same two corners. In some cases, the ordering manager 1004 generates the candidate geometries and samples the curve and the candidate geometries to generate points for comparison. From the points, the ordering manager 1004 determines centroids to compare. Based on the comparing the centroids, the geometry matching system 102 determines the order for a similarity comparison, with the candidate having the most similar (e.g., closest) centroid to that of the curve being compared for similarity first.

As further illustrated in FIG. 10, the geometry matching system 102 includes a similarity manager 1006. In particular, the similarity manager 1006 manages, maintains, determines, generates, compares, or identifies similarities between curves and candidate geometries. For example, the similarity manager 1006 utilizes a geometry matching algorithm to compare points sampled along a curve with points sampled along candidate geometries (in the determined order from the ordering manager 1004). In some cases, the similarity manager 1006 performs pairwise comparisons of points along a curve and a geometry to determine a similarity score based on a success ratio and/or an outlier ratio of points within a threshold distance of one another.

Additionally, the geometry matching system 102 includes a tracing stroke manager 1008. In particular, the tracing stroke manager 1008 manages, generates, traces, snaps, aligns, or determines tracing strokes. For example, the tracing stroke manager 1008 snaps curves a digital image to a matching geometry. As another example, the tracing stroke manager 1008 snaps input tracing strokes from a client device to a matching geometry.

The geometry matching system 102 further includes a storage manager 1010. The storage manager 1010 operates in conjunction with, or includes, one or more memory devices such as a database (e.g., the database 114) that store various data such as raster images, vector images, detected corners, curves, matching geometries and/or tracing data. As shown, the storage manager 1010 stores a corner detection algorithm 1012 accessible and usable by other components of the geometry matching system 102. In some cases, the storage manager 1010 also stores a geometry matching algorithm 1014 accessible and usable by other components of the geometry matching system 102. The storage manager 1010 communicates with the other components of the geometry matching system 102 to facilitate the operations and functions described herein.

In one or more embodiments, each of the components of the geometry matching system 102 are in communication with one another using any suitable communication technologies. Additionally, the components of the geometry matching system 102 is in communication with one or more other devices including one or more client devices described above. It will be recognized that although the components of the geometry matching system 102 are shown to be separate in FIG. 10, any of the subcomponents may be combined into fewer components, such as into a single component, or divided into more components as may serve a particular implementation. Furthermore, although the components of FIG. 10 are described in connection with the geometry matching system 102, at least some of the components for performing operations in conjunction with the geometry matching system 102 described herein may be implemented on other devices within the environment.

The components of the geometry matching system 102, in one or more implementations, includes software, hardware, or both. For example, the components of the geometry matching system 102 include one or more instructions stored on a computer-readable storage medium and executable by processors of one or more computing devices (e.g., the computing device 1000). When executed by the one or more processors, the computer-executable instructions of the geometry matching system 102 cause the computing device 1000 to perform the methods described herein. Alternatively, the components of the geometry matching system 102 comprises hardware, such as a special purpose processing device to perform a certain function or group of functions. Additionally, or alternatively, the components of the geometry matching system 102 includes a combination of computer-executable instructions and hardware.

Furthermore, the components of the geometry matching system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the geometry matching system 102 may be implemented as part of a stand-alone application on a personal computing device or a mobile device. Alternatively, or additionally, the components of the geometry matching system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

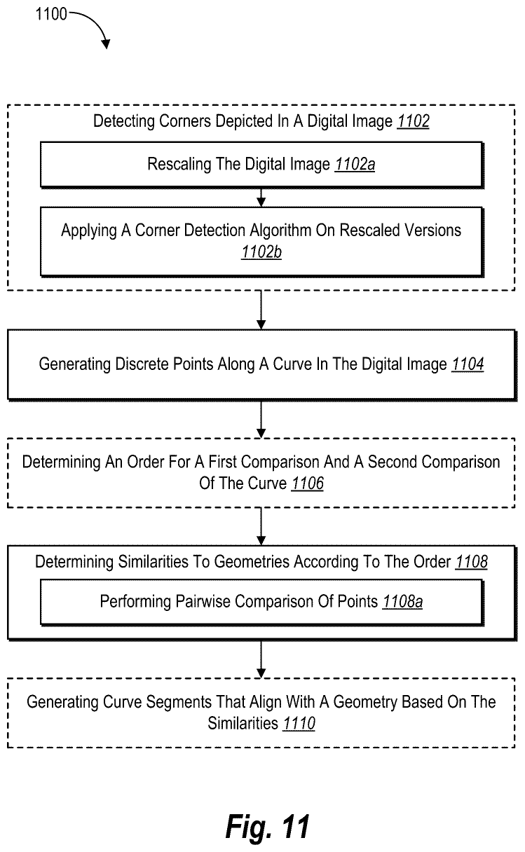

FIGS. 1-10, the corresponding text, and the examples provide a number of different systems, methods, and non-transitory computer readable media for generating and tracing matching geometries for curves of a digital image. In addition to the foregoing, embodiments are describable in terms of flowcharts comprising acts for accomplishing a particular result. For example, FIG. 11 illustrates a flowcharts of example sequences or series of acts in accordance with one or more embodiments.

While FIG. 11 illustrates acts according to particular embodiments, alternative embodiments may omit, add to, reorder, and/or modify any of the acts shown in FIG. 11. The acts of FIG. 11 are sometimes performed as part of a method. Alternatively, a non-transitory computer readable medium comprises instructions, that when executed by one or more processors, cause a computing device to perform the acts of FIG. 11. In still further embodiments, a system performs the acts of FIG. 11. Additionally, the acts described herein may be repeated or performed in parallel with one another or in parallel with different instances of the same or other similar acts.

FIG. 11 illustrates an example series of acts 1100 for generating and tracing matching geometries for curves of a digital image. In particular, the series of acts 1100 includes an act 1102 of detecting corners depicted in a digital image. For example, the act 1102 involves generating a set of discrete points along a curve depicted in a digital image by sampling the curve spanning between a first corner and a second corner depicted in the digital image. In some cases, the act 1102 includes an act 1102a of rescaling the digital image. For example, the act 1102a includes rescaling the digital image (e.g., the raster image) into multiple resized versions. In addition, the act 1102 includes an act 1102b of applying a corner detection algorithm on rescaled versions. For example, the act 1102b involves utilizing a corner detection algorithm on one or more rescaled versions of the raster image.

As illustrated in FIG. 11, the series of acts 1100 includes an act 1104 of generating discrete points along a curve in the digital image. In particular, the act 1104 involves generating a set of discrete points along a curve spanning between a first corner and a second corner from among the plurality of corners. In addition, in one or more embodiments, the series of acts 1100 includes an act 1106 of determining an order for a first comparison and a second comparison of the curve. For instance, the act 1106 involves determining an order for comparing the set of discrete points with a first geometry and a second geometry by comparing a centroid of the curve with a centroid of the first geometry and a centroid of the second geometry.

As further illustrated in FIG. 11, the series of acts 1100 includes an act 1108 of determining similarities to geometries according to the order. For example, the act 1108 involves determining, by performing pairwise comparisons of the set of discrete points according to the order, a first similarity of the curve to the first geometry and a second similarity of the curve to the second geometry. As shown, the act 1108 includes an act 1108a of performing pairwise comparisons of points. For instance, the act 1108a involves determining a first similarity of the curve to a line and a second similarity of the curve to an arc by performing pairwise comparisons of the set of discrete points with corresponding points along the line and the arc (according to the order).

Additionally, the series of acts 1100 includes an act 1110 of generating curve segments that align with a geometry based on the similarities. For example, the act 1110 involves generating curve segments that align with one of the first geometry or the second geometry according to the first similarity and the second similarity. In some cases, the act 1110 involves generating a vector image from the raster image by fitting curve segments to vector paths along one of the line or the arc according to the first similarity and the second similarity. In these or other cases, the act 1110 involves generating curve segments that align tracing inputs with one of the line or the arc according to the first similarity and the second similarity.

In one or more embodiments, the series of acts 1100 includes an act of generating the set of discrete points along the curve depicted in the digital image by uniformly sampling the curve according to a sampling interval between points in the set of discrete points. In these or other embodiments, the series of acts 1100 includes an act of determining the order for comparing the set of discrete points by: generating a first set of points defining the first geometry spanning between the first corner and the second corner in the digital image according to a first point algorithm, generating a second set of points along the second geometry spanning between the first corner and the second corner in the digital image according to a second point algorithm, and determining the centroid of the first geometry from the first set of points and the centroid of the second geometry from the second set of points.

In certain embodiments, the series of acts 1100 includes an act of determining the order for comparing the set of discrete points by: comparing the centroid of the curve with the centroid of the first geometry by determining a first distance between the centroid of the curve and the centroid of the first geometry, comparing the centroid of the curve with the centroid of the second geometry by determining a second distance between the centroid of the curve and the centroid of the second geometry, and determining the order based on the first distance and the second distance.

In some embodiments, the series of acts 1100 includes an act of generating the curve segments that align with one of the first geometry or the second geometry by: snapping the curve segments to the first geometry based on determining that the first similarity is higher than the second similarity, or snapping the curve segments to the second geometry based on determining that the second similarity is higher than the first similarity. In addition, the series of acts 1100 includes an act of detecting a plurality of corners depicted in the digital image by rescaling the digital image and utilizing a corner detection algorithm on one or more rescaled versions of the digital image. In some cases, the series of acts 1100 includes an act of generating the curve segments that align with one of the first geometry or the second geometry by: receiving input strokes from a client device drawing the curve depicted in the digital image and aligning the input strokes to one of the first geometry or the second geometry as the input strokes is received.

In certain embodiments, the series of acts 1100 includes an act of generating a vector image from the raster image by: determining a snapping threshold that defines a degree of the curve matching the line or the arc for snapping the curve segments to the line or the arc and generating, from the curve segments, the vector paths fitted to the line or the arc based on determining that the curve satisfies the snapping threshold. In one or more cases, the series of acts 1100 includes an act of receiving, from a client device, a user interaction defining the snapping threshold via a snapping threshold element.

In certain cases, the series of acts 1100 includes an act of setting the snapping threshold to a zero-percent snapping threshold that dictates snapping the curve segments to whichever of the line or the arc is most similar to the curve according to the first similarity and the second similarity. In one or more embodiments, the series of acts 1100 includes an act of detecting the plurality of corners depicted in the raster image by: performing a multi-level rescaling of the raster image to generate a plurality of rescaled versions of the raster image at respective scales, identifying detected corners using the corner detection algorithm on the plurality of rescaled versions of the raster image, and combining the detected corners from the plurality of rescaled versions of the raster image by rescaling to an initial size of the raster image.

In some embodiments, the series of acts 1100 includes an act of generating the set of discrete points along the curve depicted in the raster image by uniformly sampling the curve according to a sampling interval. In some cases, the series of acts 1100 includes an act of determining an order for comparing the set of discrete points with the line and the arc by comparing a centroid of the curve with a centroid of the line and a centroid of the arc and an act of determining the first similarity and the second similarity according to the order.

In one or more embodiments, the series of acts 1100, the series of acts 1100 includes an act of generating the curve segments by generating a vector image from the raster image by fitting vector paths along one of the line or the arc according to the first similarity and the second similarity. In addition, the series of acts 1100 includes an act of determining the first similarity comprises performing pairwise comparisons of points along the curve with corresponding points along the line and an act of determining the second similarity comprises performing pairwise comparisons of points along the curve with corresponding points along the arc.

In certain embodiments, the series of acts 1100 includes an act of determining the order for comparing the curve with the line and the arc by: generating a set of line points defining the line spanning between the first corner and the second corner in the raster image according to a line point algorithm, generating a set of arc points along the arc spanning between the first corner and the second corner in the raster image according to an arc point algorithm, and determining the centroid of the line from the set of line points and the centroid of the arc from the set of arc points. In addition, the series of acts 1100 includes an act of determining a snapping threshold that defines a degree of the curve matching the line or the arc for snapping the tracing inputs to the line or the arc and an act of generating, from the tracing inputs, the curve segments fitted to the line or the arc based on determining that the curve satisfies the snapping threshold. Further, the series of acts 1100 includes an act of setting the snapping threshold to a zero-percent snapping threshold that dictates snapping the curve segments to whichever of the line or the arc is most similar to the curve according to the first similarity and the second similarity.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 12 illustrates a block diagram of an example computing device 1200 that may be configured to perform one or more of the processes described above. One will appreciate that one or more computing devices, such as the computing device 1200 may represent the computing devices described above (e.g., computing device 1000, server device(s) 104, and/or client device 108). In one or more embodiments, the computing device 1200 may be a mobile device (e.g., a mobile telephone, a smartphone, a PDA, a tablet, a laptop, a camera, a tracker, a watch, a wearable device, etc.). In some embodiments, the computing device 1200 may be a non-mobile device (e.g., a desktop computer or another type of client device). Further, the computing device 1200 may be a server device that includes cloud-based processing and storage capabilities.

As shown in FIG. 12, the computing device 1200 can include one or more processor(s) 1202, memory 1204, a storage device 1206, input/output interfaces 1208 (or “I/O interfaces 1208”), and a communication interface 1210, which may be communicatively coupled by way of a communication infrastructure (e.g., bus 1212). While the computing device 1200 is shown in FIG. 12, the components illustrated in FIG. 12 are not intended to be limiting. Additional or alternative components may be used in other embodiments. Furthermore, in certain embodiments, the computing device 1200 includes fewer components than those shown in FIG. 12. Components of the computing device 1200 shown in FIG. 12 will now be described in additional detail.

In particular embodiments, the processor(s) 1202 includes hardware for executing instructions, such as those making up a computer program. As an example, and not by way of limitation, to execute instructions, the processor(s) 1202 may retrieve (or fetch) the instructions from an internal register, an internal cache, memory 1204, or a storage device 1206 and decode and execute them.

The computing device 1200 includes memory 1204, which is coupled to the processor(s) 1202. The memory 1204 may be used for storing data, metadata, and programs for execution by the processor(s). The memory 1204 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1204 may be internal or distributed memory.

The computing device 1200 includes a storage device 1206 includes storage for storing data or instructions. As an example, and not by way of limitation, the storage device 1206 can include a non-transitory storage medium described above. The storage device 1206 may include a hard disk drive (HDD), flash memory, a Universal Serial Bus (USB) drive or a combination these or other storage devices.

As shown, the computing device 1200 includes one or more I/O interfaces 1208, which are provided to allow a user to provide input to (such as user strokes), receive output from, and otherwise transfer data to and from the computing device 1200. These I/O interfaces 1208 may include a mouse, keypad or a keyboard, a touch screen, camera, optical scanner, network interface, modem, other known I/O devices or a combination of such I/O interfaces 1208. The touch screen may be activated with a stylus or a finger.

The I/O interfaces 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1208 are configured to provide graphical data to a display for presentation to a user. The graphical data may be representative of one or more graphical user interfaces and/or any other graphical content as may serve a particular implementation.

The computing device 1200 can further include a communication interface 1210. The communication interface 1210 can include hardware, software, or both. The communication interface 1210 provides one or more interfaces for communication (such as, for example, packet-based communication) between the computing device and one or more other computing devices or one or more networks. As an example, and not by way of limitation, communication interface 1210 may include a network interface controller (NIC) or network adapter for communicating with an Ethernet or other wire-based network or a wireless NIC (WNIC) or wireless adapter for communicating with a wireless network, such as a WI-FI. The computing device 1200 can further include a bus 1212. The bus 1212 can include hardware, software, or both that connects components of computing device 1200 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
generating a set of discrete points along a curve depicted in a digital image by sampling the curve spanning between a first corner and a second corner depicted in the digital image;
determining an order for comparing the set of discrete points with a first geometry and a second geometry by comparing a centroid of the curve with a centroid of the first geometry and a centroid of the second geometry;
determining, by performing pairwise comparisons of the set of discrete points according to the order, a first similarity of the curve to the first geometry and a second similarity of the curve to the second geometry; and
generating curve segments that align with one of the first geometry or the second geometry according to the first similarity and the second similarity.

2. The method of claim 1, wherein generating the set of discrete points along the curve depicted in the digital image comprises uniformly sampling the curve according to a sampling interval between points in the set of discrete points.

3. The method of claim 1, wherein determining the order for comparing the set of discrete points comprises:
generating a first set of points defining the first geometry spanning between the first corner and the second corner in the digital image according to a first point algorithm;
generating a second set of points along the second geometry spanning between the first corner and the second corner in the digital image according to a second point algorithm; and
determining the centroid of the first geometry from the first set of points and the centroid of the second geometry from the second set of points.

4. The method of claim 1, wherein determining the order for comparing the set of discrete points comprises:
comparing the centroid of the curve with the centroid of the first geometry by determining a first distance between the centroid of the curve and the centroid of the first geometry;
comparing the centroid of the curve with the centroid of the second geometry by determining a second distance between the centroid of the curve and the centroid of the second geometry; and
determining the order based on the first distance and the second distance.

5. The method of claim 1, wherein generating the curve segments that align with one of the first geometry or the second geometry comprises:
snapping the curve segments to the first geometry based on determining that the first similarity is higher than the second similarity; or
snapping the curve segments to the second geometry based on determining that the second similarity is higher than the first similarity.

6. The method of claim 1, further comprising detecting a plurality of corners depicted in the digital image by rescaling the digital image and utilizing a corner detection algorithm on one or more rescaled versions of the digital image.

7. The method of claim 1, wherein generating the curve segments that align with one of the first geometry or the second geometry comprises:
receiving input strokes from a client device drawing the curve depicted in the digital image; and
aligning the input strokes to one of the first geometry or the second geometry as the input strokes is received.

8. A system comprising:
a memory component; and
one or more processing devices coupled to the memory component, the one or more processing devices to perform operations comprising:
detecting a plurality of corners depicted in a raster image by rescaling the raster image and utilizing a corner detection algorithm on one or more rescaled versions of the raster image;
generating a set of discrete points along a curve spanning between a first corner and a second corner from among the plurality of corners;
determining a first similarity of the curve to a line and a second similarity of the curve to an arc by performing pairwise comparisons of the set of discrete points with corresponding points along the line and the arc; and
generating a vector image from the raster image by fitting curve segments to vector paths along one of the line or the arc according to the first similarity and the second similarity.

9. The system of claim 8, wherein generating a vector image from the raster image comprises:
determining a snapping threshold that defines a degree of the curve matching the line or the arc for snapping the curve segments to the line or the arc; and
generating, from the curve segments, the vector paths fitted to the line or the arc based on determining that the curve satisfies the snapping threshold.

10. The system of claim 9, wherein the operations further comprise receiving, from a client device, a user interaction defining the snapping threshold via a snapping threshold element.

11. The system of claim 9, wherein the operations further comprise setting the snapping threshold to a zero-percent snapping threshold that dictates snapping the curve segments to whichever of the line or the arc is most similar to the curve according to the first similarity and the second similarity.

12. The system of claim 8, wherein detecting the plurality of corners depicted in the raster image comprises:
performing a multi-level rescaling of the raster image to generate a plurality of rescaled versions of the raster image at respective scales;
identifying detected corners using the corner detection algorithm on the plurality of rescaled versions of the raster image; and
combining the detected corners from the plurality of rescaled versions of the raster image by rescaling to an initial size of the raster image.

13. The system of claim 8, wherein generating the set of discrete points along the curve depicted in the raster image comprises uniformly sampling the curve according to a sampling interval.

14. The system of claim 8, wherein the operations further comprise:
determining an order for comparing the set of discrete points with the line and the arc by comparing a centroid of the curve with a centroid of the line and a centroid of the arc; and
determining the first similarity and the second similarity according to the order.

15. A non-transitory computer readable medium storing instructions which, when executed by a processing device, cause the processing device to perform operations comprising:
detecting a plurality of corners depicted in a raster image by rescaling the raster image and utilizing a corner detection algorithm on one or more rescaled versions of the raster image;
determining, for a curve in the raster image spanning between a first corner and a second corner from among the plurality of corners, an order for comparing the curve with a line and an arc by comparing a centroid of the curve with a centroid of the line and a centroid of the arc;
determining a first similarity of the curve to the line and a second similarity of the curve to the arc according to the order; and
generating curve segments that align tracing inputs with one of the line or the arc according to the first similarity and the second similarity.

16. The non-transitory computer readable medium of claim 15, wherein generating the curve segments comprises generating a vector image from the raster image by fitting vector paths along one of the line or the arc according to the first similarity and the second similarity.

17. The non-transitory computer readable medium of claim 15, wherein:
determining the first similarity comprises performing pairwise comparisons of points along the curve with corresponding points along the line; and
determining the second similarity comprises performing pairwise comparisons of points along the curve with corresponding points along the arc.

18. The non-transitory computer readable medium of claim 15, wherein determining the order for comparing the curve with the line and the arc comprises:
generating a set of line points defining the line spanning between the first corner and the second corner in the raster image according to a line point algorithm;
generating a set of arc points along the arc spanning between the first corner and the second corner in the raster image according to an arc point algorithm; and
determining the centroid of the line from the set of line points and the centroid of the arc from the set of arc points.

19. The non-transitory computer readable medium of claim 15, wherein the operations further comprise:
determining a snapping threshold that defines a degree of the curve matching the line or the arc for snapping the tracing inputs to the line or the arc; and
generating, from the tracing inputs, the curve segments fitted to the line or the arc based on determining that the curve satisfies the snapping threshold.

20. The non-transitory computer readable medium of claim 19, wherein the operations further comprise setting the snapping threshold to a zero-percent snapping threshold that dictates snapping the curve segments to whichever of the line or the arc is most similar to the curve according to the first similarity and the second similarity.
